(19) United States
(12) Patent Application Publication
(10) Pub. No.: US 2024/0424353 A1
(43) Pub. Date: Dec. 26, 2024

(54) GOLF BALL

(71) Applicant: Sumitomo Rubber Industries, Ltd., Kobe-shi (JP)

(72) Inventors: Takahiro SAJIMA, Kobe-shi (JP); Daijiro KOJIMA, Kobe-shi (JP)

(73) Assignee: Sumitomo Rubber Industries, Ltd., Kobe-shi (JP)

(21) Appl. No.: 18/745,380

(22) Filed: Jun. 17, 2024

(30) Foreign Application Priority Data
Jun. 21, 2023 (JP) 2023-101990

(51) Int. Cl. A63B 37/00; C08L 9/00

(52) U.S. Cl. CPC A63B 37/0091; A63B 37/0017; A63B 37/0031; A63B 37/00621; A63B 37/00622; A63B 37/0063; C08L 9/00; A63B 37/0074; A63B 37/0075; A63B 37/0076; C08L 2205/03; C08L 2312/00

(57) ABSTRACT

An object of the present disclosure is to provide a golf ball having an excellent flight distance and stability on a second or subsequent shot while maintaining or improving a flight distance on a driver shot for a golfer with a slow head speed. The present disclosure provides a golf ball comprising a spherical core, and an outermost cover positioned outside the spherical core and having a plurality of dimples formed thereon, wherein a hardness difference S (=Hs−Ho) between a surface hardness Hs of the spherical core and a center hardness Ho (Shore C hardness) of the spherical core, a material hardness C (Shore D hardness) of the outermost cover, and a total volume V (mm³) of the plurality of dimples below a surface of a phantom sphere satisfy V−S×C≥0.

### FIELD OF THE DISCLOSURE

The present disclosure relates to a golf ball, and particularly relates to a golf ball suitable for a golfer with a slow head speed.

### DESCRIPTION OF THE RELATED ART

Not only a flight distance on a driver shot but also a flight distance and shot stability on a second or subsequent shot of a golf ball are important to make a good golf score. In recent years, senior golfers and female golfers increase, and these golfers hitting a golf ball at a slow head speed have a strong demand that the golf ball does not only travel a great flight distance on a driver shot, but also has an excellent flight distance performance and stability on a second or subsequent shot.

Dimples are provided on a surface of a golf ball. The flight performance of the golf ball has been improved by improving the dimples.

For example, JP 2016-7369 A discloses a golf ball having a large number of dimples on a surface thereof, and satisfying the following mathematical formula (I):

1.320≤L1≤1.420 (I)
wherein in the mathematical formula (I), L1 represents a ratio of a lift force coefficient CL1 which is measured under conditions of a Reynolds number of 1.290×10⁵ and a spin rate of 2820 rpm, relative to a lift force coefficient CL2 which is measured under conditions of a Reynolds number of 1.290×10⁵ and a spin rate of 1740 rpm.

### SUMMARY OF THE DISCLOSURE

An object of the present disclosure is to provide a golf ball having an excellent flight distance and stability on a second or subsequent shot while maintaining or improving a flight distance on a driver shot for a golfer with a slow head speed.

A golf ball showing a high spin rate is effective for aiming at a pin on a short iron shot or on an approach shot around the green. Rolling (run) which is an uncertain element for the short iron shot can be suppressed, and slipping of a golf ball, which is an uncertain element on the approach shot can be suppressed. On the other hand, a golf ball having a large total volume of dimples controls a lift force due to the dimples. In other words, the golf ball having a large total volume of dimples suppresses excessive lift of the trajectory particularly on a middle iron shot that generates a relatively high backspin rate at shotting. A flight distance as well as accuracy is required for a middle iron shot, thus the golf ball having a larger total volume of dimples tends to travel a greater flight distance.

A golf ball with a high spin rate and a large total volume of dimples is considered appropriate for providing the flight distance or stability on a second or subsequent shot. However, the spin rate or the total volume of dimples of the golf ball greatly affect the flight distance on a driver shot.

The present inventors have found that a golf ball with a high spin rate and a large total volume of dimples travels a short flight distance on a driver shot when being hit at a head speed in a range from 35 m/s to 45 m/s which is a head speed of an average golfer, but maintains or increases a flight distance on a driver shot when being hit at a slow head speed of less than 35 m/s, and thus has achieved the present disclosure.

In other words, the present disclosure provides a golf ball comprising a spherical core, and an outermost cover positioned outside the spherical core and having a plurality of dimples formed thereon, wherein a hardness difference S (=Hs−Ho) between a surface hardness Hs of the spherical core and a center hardness Ho (Shore C hardness) of the spherical core, a material hardness C (Shore D hardness) of the outermost cover, and a total volume V (mm³) of the plurality of dimples below a surface of a virtual sphere satisfy V−S×C≥0.

If the golf ball according to the present disclosure is constituted as above, the lift force caused by the dimples can be controlled while keeping the appropriate spin rate. The balance between the lift force arising from the spin and the lift force arising from the dimples becomes appropriate, and thus the flight distance and stability of the golf ball on a second or subsequent shot is excellent while maintaining or improving the flight distance on a driver shot.

According to the present disclosure, a golf ball having an excellent flight distance and stability on a second or subsequent shot while maintaining or improving a flight distance on a driver shot for a golfer with a slow head speed can be provided.

### BRIEF DESCRIPTION OF THE DRAWINGS

FIG. 1 is a schematic cross-sectional view of a golf ball according to one embodiment of the present disclosure;

FIG. 2 is an enlarged front view of the golf ball shown in FIG. 1;

FIG. 3 is a plane view of the golf ball shown in FIG. 2; and

FIG. 4 is a partially enlarged cross-sectional view of the golf ball shown in FIG. 1.

### DESCRIPTION OF THE PREFERRED EMBODIMENT

The golf ball according to the present disclosure comprises a spherical core, and an outermost cover positioned outside the spherical core and having a plurality of dimples formed thereon.

In the golf ball according to the present disclosure, a hardness difference S (=Hs−Ho) between a surface hardness Hs of the spherical core and a center hardness Ho (Shore C hardness) of the spherical core, a material hardness (Shore D hardness) C of the outermost cover, and a total volume V (mm³) of the plurality of dimples below a surface of a virtual sphere satisfy V−S×C≥0.

The value (V−S×C) is preferably 0 or more, more preferably 150 or more, and even more preferably 200 or more, and is preferably 750 or less, more preferably 700 or less, and even more preferably 650 or less. If the value (V−(S×C)) falls within the above range, a good balance is struck between the flight distance on a driver shot and the flight performance on a second or subsequent shot.

The value (S+C) is preferably 30 or more, more preferably 40 or more, and even more preferably 50 or more, and is preferably 60 or less, more preferably 58 or less, and even more preferably 56 or less. If the value (S+C) falls within the above range, a better balance is struck between the flight distance on a driver shot and the flight performance on a second or subsequent shot.

The golf ball according to the present disclosure comprises an outermost cover having a plurality of dimples formed thereon. The dimples are concaves formed on the outermost cover. Next, the dimples formed on the outermost cover of the golf ball according to the present disclosure will be described with reference to the figures.

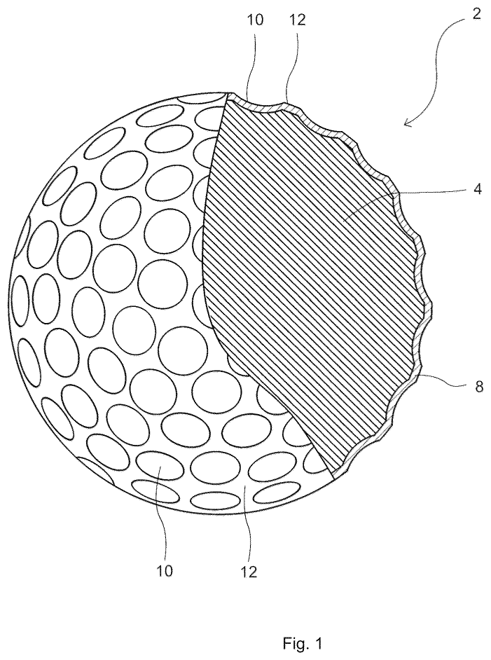

A golf ball 2 shown in FIG. 1 comprises a spherical core 4 and an outermost cover 8 positioned outside the core 4. The golf ball 2 has a plurality of dimples 10 on the surface. Other portions than the dimples 10 on the surface of the golf ball 2 are lands 12. The golf ball 2 is provided with a paint layer and a mark layer on an outer side of the outermost cover 8, but these layers are not depicted.

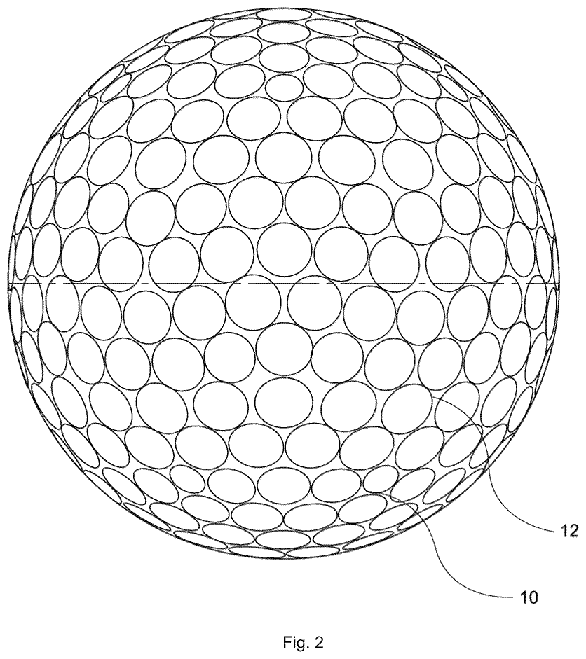

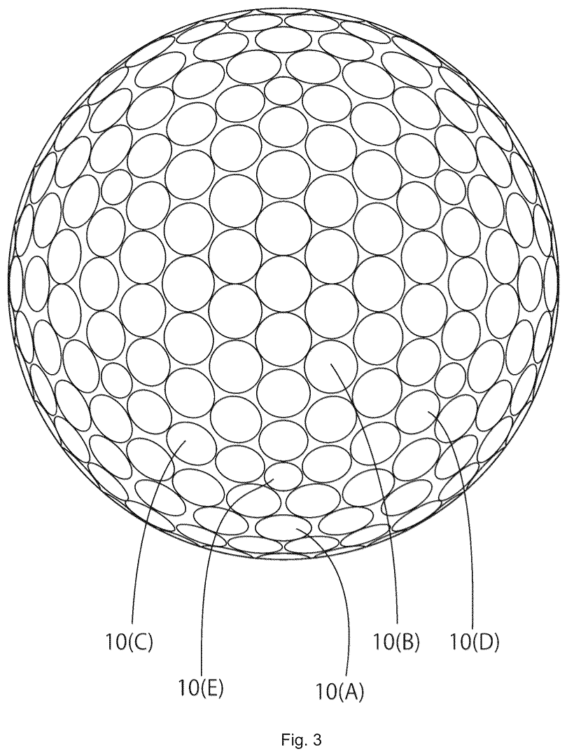

As shown in FIG. 2 and FIG. 3, the outermost cover of the golf ball 2 has a plurality of dimples 10 formed on the surface. Each of the dimples 10 has a circle contour.

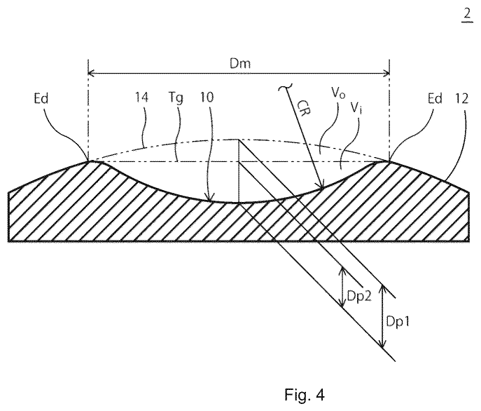

FIG. 4 shows a cross section of the golf ball 2 along a plane passing through the central point of the dimple 10 and the central point of the golf ball 2. The top-to-bottom direction in FIG. 4 is the depth direction of the dimple 10. In FIG. 4, a chain double-dashed line 14 indicates a virtual sphere. The surface of the virtual sphere 14 is the surface of the golf ball 2 when it is virtualized that no dimple 10 exists. The diameter of the virtual sphere 14 is equal to the diameter of the golf ball 2. The dimple 10 is recessed from the surface of the virtual sphere 14. The land 12 coincides with the surface of the virtual sphere 14. In the present embodiment, the cross-sectional shape of the dimple 10 is substantially a circular arc. The curvature radius of this circular arc is shown by a reference sign CR in FIG. 4.

In FIG. 4, an arrow Dm indicates the diameter of the dimple 10. The diameter Dm is a distance between one tangent point Ed and another tangent point Ed when a tangent line Tg traversing two sides of the dimple 10 is drawn. The tangent point Ed is also the edge of the dimple 10. The edge Ed defines the contour of the dimple 10.

In the present disclosure, the “volume of the dimple” means the volume of the portion surrounded by the surface of the dimple 10 and the surface of the virtual sphere including the contour of the dimple 10. The “volume of the dimple” is divided by a plane connecting intersection points Ed-Ed of the surface of the virtual sphere 14 with the surface of the dimple. The “upper volume of the dimple” is the volume of the dimple upper part surrounded by the surface of the virtual sphere 14 and the plane connecting the intersection points Ed-Ed of the surface of the dimple. The “lower volume of the dimple” is the volume of the dimple lower part surrounded by the plane connecting the intersection points Ed-Ed of the surface of the dimple and the surface of the dimple 10. The volume of the dimple is the sum of the upper volume and the lower volume. The “total volume V of the dimples” in the present disclosure is the sum of the volume of all the dimples. The “total upper volume Vo of the dimples” is the sum of the upper volume of all the dimples. The “total lower volume Vi of the dimples” is the sum of the lower volume of all the dimples.

In the present disclosure, the total volume V of the dimples 10 is preferably 500 mm³ or more and 900 mm³ or less. The golf ball 2 with a total volume V of 500 mm³ or more has suppressed hop during the flight. From this viewpoint, the total volume V is more preferably 520 mm³ or more, and particularly preferably 540 mm³ or more. The golf ball 2 with a total volume V of 900 mm³ or less has suppressed drop during the flight. From this viewpoint, the total volume V is more preferably 880 mm³ or less, and particularly preferably 860 mm³ or less.

When the total upper volume of the dimples is Vo, and the total lower volume of the dimples is Vi, V=Vo+Vi is given. In the present disclosure, Vi−1.85×Vo≥0 is preferably satisfied. The value (Vi−1.85×Vo) is preferably 0 or more, more preferably 30 or more, and even more preferably 60 or more, and is preferably 160 or less, more preferably 140 or less, and even more preferably 120 or less. If the value (Vi−1.85×Vo) falls within the above range, the lift force due to the dimples can be controlled, and thus the flight distance on a driver shot is further increased.

The diameter Dm of the respective dimples 10 is preferably 2.0 mm or more and 6.0 mm or less. The dimple 10 having a diameter Dm of 2.0 mm or more contributes to turbulence. From this viewpoint, the diameter Dm is more preferably 2.5 mm or more, and particularly preferably 2.8 mm or more. The dimple 10 having a diameter Dm of 6.0 mm or less does not impair the nature of the golf ball 2 that is substantially a sphere. From this viewpoint, the diameter Dm is more preferably 5.5 mm or less, and particularly preferably 5.0 mm or less.

In FIG. 4, a double ended arrow Dp1 indicates a first depth of the dimple 10. The first depth Dp1 is the distance between the deepest part of the dimple 10 and the surface of the virtual sphere 14. In FIG. 4, a double ended arrow Dp2 indicates a second depth of the dimple 10. The second depth Dp2 is the distance between the deepest part of the dimple 10 and the tangent line Tg.

From the viewpoint of suppressing the hop of the golf ball 2, the first depth Dp1 of the dimple 10 is preferably 0.10 mm or more, more preferably 0.13 mm or more, and even more preferably 0.15 mm or more. From the viewpoint of suppressing the drop of the golf ball 2, the first depth Dp1 is preferably 0.65 mm or less, more preferably 0.60 mm or less, and even more preferably 0.55 mm or less.

The area A of the dimple 10 is the area of a region surrounded by the contour of the dimple 10 when the central point of the golf ball 2 is viewed at infinity. In the case that the dimple 10 has a circular shape, the area A is calculated by the following mathematical formula.

$$A = {( Dm / 2 )}^{2 *} π$$

In the present disclosure, the ratio of the sum of the areas A of all the dimples 10 to the surface area of the virtual sphere 14 is referred to as an occupation ratio So. From the viewpoint of obtaining the sufficient turbulence, the occupation ratio So is preferably 70% or more, more preferably 75% or more, and even more preferably 80% or more. The occupation ratio So is preferably 95% or less. In the golf ball 2 shown in FIGS. 2 and 3, the total area of the dimples 10 is 4707 mm², and the surface area of the virtual sphere 14 of the golf ball 2 is 5728 mm², so the occupation ratio So is 81.6%.

From the viewpoint of achieving the sufficient occupation ratio So, the total number of the dimples 10 is preferably 250 or more, more preferably 280 or more, and even more preferably 300 or more. From the viewpoint that the respective dimple 10 can contribute to turbulence, the total number of the dimples 10 is preferably 450 or less, more preferably 410 or less, and even more preferably 390 or less.

The golf ball 2 according to the present disclosure has a dimple A with a diameter of 4.400 mm, a dimple B with a diameter of 4.285 mm, a dimple C with a diameter of 4.150 mm, a dimple D with a diameter of 3.875 mm, and a dimple E with a diameter of 3.000 mm. The dimples 10 have five types.

In the golf ball 2 shown in FIG. 2 and FIG. 3, the area of the dimple A is 15.21 mm², the area of the dimple B is 14.42 mm², the area of the dimple C is 13.53 mm², the area of the dimple D is 11.79 mm², and the area of the dimple E is 7.07 mm².

The construction of the golf ball according to the present disclosure is not particularly limited, as long as the golf ball comprises a spherical core and an outermost cover positioned outside the spherical core. Examples of the construction of the golf ball according to the present disclosure include a two-piece golf ball composed of a single-layered spherical core and a single-layered cover covering the spherical core; a three-piece golf ball composed of a single-layered spherical core, an inner cover covering the spherical core, and an outermost cover covering the inner cover; a multi-piece golf ball (including a four-piece golf ball, a five-piece golf ball, and the like) composed of a single-layered spherical core, two or more inner covers covering the spherical core, and an outermost cover covering the inner covers. It is noted that the inner cover is sometimes referred to as an outer core or intermediate layer depending on the construction of the golf ball.

The spherical core of the golf ball according to the present disclosure is preferably formed from a rubber composition (hereinafter sometimes referred to as “core rubber composition”) containing (a) a base rubber, (b) an α,β3-unsaturated carboxylic acid having 3 to 8 carbon atoms and/or a metal salt thereof as a co-crosslinking agent, and (c) a crosslinking initiator.

As (a) the base rubber, a natural rubber and/or a synthetic rubber can be used. For example, a polybutadiene rubber, a natural rubber, a polyisoprene rubber, a styrene polybutadiene rubber, or an ethylene-propylene-diene rubber (EPDM) can be used. These rubbers may be used solely, or at least two of these rubbers may be used in combination. Among them, particularly preferred is a high-cis polybutadiene having a cis-1,4 bond in an amount of 40 mass % or more, preferably 80 mass % or more, and more preferably 90 mass % or more in view of its superior resilience.

The high-cis polybutadiene preferably has a 1,2-vinyl bond in an amount of 2 mass % or less, more preferably 1.7 mass % or less, and even more preferably 1.5 mass % or less. If the amount of the 1,2-vinyl bond is 2 mass % or less, the resilience is better.

The high-cis polybutadiene is preferably one synthesized using a rare-earth element catalyst. When a neodymium catalyst employing a neodymium compound which is a lanthanum series rare-earth element compound, is used, a polybutadiene rubber having a high amount of the cis-1,4 bond and a low amount of the 1,2-vinyl bond is obtained with an excellent polymerization activity, and thus such polybutadiene rubber is particularly preferable.

The Mooney viscosity (ML₁₊₄ (100° C.)) of the high-cis polybutadiene is preferably 30 or more, more preferably 32 or more, and even more preferably 35 or more, and is preferably 140 or less, more preferably 120 or less, even more preferably 100 or less, and most preferably 80 or less. It is noted that the Mooney viscosity (ML₁₊₄ (100° C.)) in the present disclosure is a value measured according to JIS K6300 using an L rotor under the conditions of preheating time: 1 minute, rotor rotation time: 4 minutes, and temperature: 100° C.

The molecular weight distribution Mw/Mn (Mw: weight average molecular weight, Mn: number average molecular weight) of the high-cis polybutadiene is preferably 2.0 or more, more preferably 2.2 or more, even more preferably 2.4 or more, and most preferably 2.6 or more, and is preferably 6.0 or less, more preferably 5.0 or less, even more preferably 4.0 or less, and most preferably 3.4 or less. If the molecular weight distribution (Mw/Mn) of the high-cis polybutadiene is 2.0 or more, the processability is better, and if the molecular weight distribution (Mw/Mn) of the high-cis polybutadiene is 6.0 or less, the resilience is higher. It is noted that the molecular weight distribution is measured by gel permeation chromatography (“HLC-8120GPC” available from Tosoh Corporation) using a differential refractometer as a detector under the conditions of column: GMHHXL (available from Tosoh Corporation), column temperature: 40° C., and mobile phase: tetrahydrofuran, and calculated by converting based on polystyrene standard.

(b) The α,β-unsaturated carboxylic acid having 3 to 8 carbon atoms and/or the metal salt thereof is blended as a co-crosslinking agent in the rubber composition, and has an action of crosslinking a rubber molecule by graft polymerization to a base rubber molecular chain.

Examples of the α,β-unsaturated carboxylic acid having 3 to 8 carbon atoms include acrylic acid, methacrylic acid, fumaric acid, maleic acid and crotonic acid.

Examples of the metal ion constituting the metal salt of the α,β-unsaturated carboxylic acid having 3 to 8 carbon atoms include a monovalent metal ion such as sodium, potassium and lithium; a divalent metal ion such as magnesium, calcium, zinc, barium and cadmium; a trivalent metal ion such as aluminum; and other metal ions such as tin and zirconium. The above metal component may be used solely or as a mixture of at least two of them. Among them, the divalent metal ion such as magnesium, calcium, zinc, barium and cadmium is preferably used as the metal component. This is because if the divalent metal salt of the α,β-unsaturated carboxylic acid having 3 to 8 carbon atoms is used, a metal crosslinking easily generates between the rubber molecules. Especially, as the divalent metal salt, zinc acrylate is preferable, because zinc acrylate enhances the resilience of the obtained golf ball. It is noted that the α,β-unsaturated carboxylic acid having 3 to 8 carbon atoms and/or the metal salt thereof may be used solely or as a mixture of at least two of them.

The amount of (b) the α,β-unsaturated carboxylic acid having 3 to 8 carbon atoms and/or the metal salt thereof is preferably 15 parts by mass or more, more preferably 20 parts by mass or more, and even more preferably 25 parts by mass or more, and is preferably 50 parts by mass or less, more preferably 40 parts by mass or less, and even more preferably 30 parts by mass or less, with respect to 100 parts by mass of (a) the base rubber. If the amount of (b) the α,β-unsaturated carboxylic acid having 3 to 8 carbon atoms and/or the metal salt thereof is 15 parts by mass or more, the formed core has a suitable hardness, and thus the golf ball has better resilience. On the other hand, if the amount of (b) the α,β-unsaturated carboxylic acid having 3 to 8 carbon atoms and/or the metal salt thereof is 50 parts by mass or less, the formed core is not excessively hard, and thus the golf ball has better shot feeling.

(c) The crosslinking initiator is blended to crosslink (a) the base rubber component. As (c) the crosslinking initiator, an organic peroxide is suitable. Specific examples of the organic peroxide include dicumyl peroxide, 1,1-bis(t-butylperoxy)-3,3,5-trimethylcyclohexane, 2,5-dimethyl-2,5-di(t-butylperoxy)hexane and di-t-butyl peroxide. These organic peroxides may be used solely or as a mixture of at least two of them. Among them, dicumyl peroxide is preferably used.

The amount of (c) the crosslinking initiator is preferably 0.2 part by mass or more, more preferably 0.4 part by mass or more, and even more preferably 0.6 part by mass or more, and is preferably 5.0 parts by mass or less, more preferably 2.5 parts by mass or less, and even more preferably 1.0 part by mass or less, with respect to 100 parts by mass of (a) the base rubber. If the amount of (c) the crosslinking initiator falls within the above range, the formed core has more suitable hardness and thus the golf ball has better resilience.

In the case that the co-crosslinking agent of the rubber composition consists of the α,β-unsaturated carboxylic acid having 3 to 8 carbon atoms, the rubber composition preferably further contains (d) a metal compound. This is because if the α,β-unsaturated carboxylic acid having 3 to 8 carbon atoms is neutralized with the metal compound in the rubber composition, substantially the same effect as using the metal salt of the α,β-unsaturated carboxylic acid having 3 to 8 carbon atoms as the co-crosslinking agent is provided. In addition, in the case that the α,β-unsaturated carboxylic acid having 3 to 8 carbon atoms and the metal salt thereof are used in combination as the co-crosslinking agent, (d) the metal compound may be used.

(d) The metal compound is not particularly limited, as long as it can neutralize (b) the α,β-unsaturated carboxylic acid having 3 to 8 carbon atoms in the rubber composition. Examples of (d) the metal compound include a metal hydroxide such as magnesium hydroxide, zinc hydroxide, calcium hydroxide, sodium hydroxide, lithium hydroxide, potassium hydroxide, and copper hydroxide; a metal oxide such as magnesium oxide, calcium oxide, zinc oxide, and copper oxide; and a metal carbonate such as magnesium carbonate, zinc carbonate, calcium carbonate, sodium carbonate, lithium carbonate, and potassium carbonate. As (d) the metal compound, the divalent metal compound is preferable, the zinc compound is more preferable. This is because the divalent metal compound reacts with the α,β-unsaturated carboxylic acid having 3 to 8 carbon atoms to form a metal crosslinking. In addition, use of the zinc compound provides a golf ball with higher resilience. (d) The metal compound may be used solely, or at least two of them may be used in combination.

The rubber composition preferably further contains (e) an organic sulfur compound. (e) The organic sulfur compound is not particularly limited, as long as it is an organic compound having a sulfur atom in the molecule thereof. Examples of (e) the organic sulfur compound include an organic compound having a thiol group (—SH) or a polysulfide bond having 2 to 4 sulfur atoms (—S—S—, —S—S—S—, or —S—S—S—S—), and a metal salt thereof (—SM, —S-M-S— or the like; M is a metal atom). Examples of (e) the organic sulfur compound include thiophenols, thionaphthols, polysulfides, thiurams, thiocarboxylic acids, dithiocarboxylic acids, sulfenamides, dithiocarbamates, and thiazoles.

Examples of the thiophenols include thiophenol; thiophenols substituted with a fluoro group, such as 4-fluorothiophenol, 2,4-difluorothiophenol, 2,5-difluorothiophenol, 2,6-difluorothiophenol, 2,4,5-trifluorothiophenol, 2,4,5,6-tetrafluorothiophenol, and pentafluorothiophenol; thiophenols substituted with a chloro group, such as 2-chlorothiophenol, 4-chlorothiophenol, 2,4-dichlorothiophenol, 2,5-dichlorothiophenol, 2,6-dichlorothiophenol, 2,4,5-trichlorothiophenol, 2,4,5,6-tetrachlorothiophenol, and pentachlorothiophenol; thiophenols substituted with a bromo group, such as 4-bromothiophenol, 2,4-dibromothiophenol, 2,5-dibromothiophenol, 2,6-dibromothiophenol, 2,4,5-tribromothiophenol, 2,4,5,6-tetrabromothiophenol, and pentabromothiophenol; thiophenols substituted with an iodo group, such as 4-iodothiophenol, 2,4-diiodothiophenol, 2,5-diiodothiophenol, 2,6-diiodothiophenol, 2,4,5-triiodothiophenol, 2,4,5,6-tetraiodothiophenol, and pentaiodothiophenol; and their metal salts.

Examples of the thionaphthols (naphthalenethiols) include 2-thionaphthol, 1-thionaphthol, 1-chloro-2-thionaphthol, 2-chloro-1-thionaphthol, 1-bromo-2-thionaphthol, 2-bromo-1-thionaphthol, 1-fluoro-2-thionaphthol, 2-fluoro-1-thionaphthol, 1-cyano-2-thionaphthol, 2-cyano-1-thionaphthol, 1-acetyl-2-thionaphthol, 2-acetyl-1-thionaphthol, and their metal salts.

The polysulfides are organic sulfur compounds having a polysulfide bond, and examples thereof include disulfides, trisulfides, and tetrasulfides. As the polysulfides, diphenyl polysulfides are preferable.

Examples of the diphenyl polysulfides include diphenyl disulfide; diphenyl disulfides substituted with a halogen group, such as bis(4-fluorophenyl)disulfide, bis(2,5-difluorophenyl)disulfide, bis(2,6-difluorophenyl)disulfide, bis(2,4,5-trifluorophenyl)disulfide, bis(2,4,5,6-tetrafluorophenyl)disulfide, bis(pentafluorophenyl)disulfide, bis(4-chlorophenyl)disulfide, bis(2,5-dichlorophenyl)disulfide, bis(2,6-dichlorophenyl)disulfide, bis(2,4,5-trichlorophenyl)disulfide, bis(2,4,5,6-tetrachlorophenyl)disulfide, bis(pentachlorophenyl)disulfide, bis(4-bromophenyl)disulfide, bis(2,5-dibromophenyl)disulfide, bis(2,6-dibromophenyl)disulfide, bis(2,4,5-tribromophenyl)disulfide, bis(2,4,5,6-tetrabromophenyl)disulfide, bis(pentabromophenyl)disulfide, bis(4-iodophenyl)disulfide, bis(2,5-diiodophenyl)disulfide, bis(2,6-diiodophenyl)disulfide, bis(2,4,5-triiodophenyl)disulfide, bis(2,4,5,6-tetraiodophenyl)disulfide, and bis(pentaiodophenyl)disulfide; and diphenyl disulfides substituted with an alkyl group, such as bis(4-methylphenyl)disulfide, bis(2,4,5-trimethylphenyl)disulfide, bis(pentamethylphenyl)disulfide, bis(4-t-butylphenyl)disulfide, bis(2,4,5-tri-t-butylphenyl)disulfide, and bis(penta-t-butylphenyl)disulfide.

Examples of the thiurams include thiuram monosulfides such as tetramethylthiuram monosulfide; thiuram disulfides such as tetramethylthiuram disulfide, tetraethylthiuram disulfide, and tetrabutylthiuram disulfide; and thiuram tetrasulfides such as dipentamethylenethiuram tetrasulfide. Examples of the thiocarboxylic acids include a naphthalene thiocarboxylic acid. Examples of the dithiocarboxylic acids include a naphthalene dithiocarboxylic acid. Examples of the sulfenamides include N-cyclohexyl-2-benzothiazole sulfenamide, N-oxydiethylene-2-benzothiazole sulfenamide, and N-t-butyl-2-benzothiazole sulfenamide.

(e) The organic sulfur compound may be used solely or as a mixture of at least two of them.

The amount of (e) the organic sulfur compound is preferably 0.05 part by mass or more, more preferably 0.1 part by mass or more, and even more preferably 0.2 part by mass or more, and is preferably 5.0 parts by mass or less, more preferably 3.0 parts by mass or less, and even more preferably 2.0 parts by mass or less, with respect to 100 parts by mass of (a) the base rubber. If the amount of (e) the organic sulfur compound falls within the above range, the resilience is better.

The rubber composition may further contain (f) a carboxylic acid and/or a metal salt thereof. As (f) the carboxylic acid and/or the metal salt thereof, a carboxylic acid having 1 to 30 carbon atoms and/or a metal salt thereof is preferable. As the carboxylic acid, an aliphatic carboxylic acid (a saturated fatty acid or an unsaturated fatty acid), or an aromatic carboxylic acid (benzoic acid) can be used. The amount of (f) the carboxylic acid and/or the metal salt thereof is preferably 1 part by mass or more and 40 parts by mass or less with respect to 100 parts by mass of the base rubber.

The rubber composition may further contain (g) a terpene-based resin. The terpene-based resin is not particularly limited, as long as it is a polymer having a terpene compound as a constituent component. As the terpene-based resin, for example, at least one member selected from the group consisting of a terpene polymer, a terpene-phenol copolymer, a terpene-styrene copolymer, a terpene-phenol-styrene copolymer, a hydrogenated terpene-phenol copolymer, a hydrogenated terpene-styrene copolymer, and a hydrogenated terpene-phenol-styrene copolymer, is preferable.

The terpene polymer is a homopolymer obtained by polymerizing the terpene compound. The terpene compound is a hydrocarbon represented by (C₅H₈)ₙ or an oxygen-containing derivate thereof, and is a compound having a terpene classified into monoterpene (C₁₀H₁₆), sesquiterpene (C₁₅H₂₄), diterpene (C₂₀H₃₂) or the like, as a basic skeleton. Examples of the terpene compound include α-pinene, β-pinene, dipentene, limonene, myrcene, alloocimene, ocimene, α-phellandrene, α-terpinene, γ-terpinene, terpinolene, 1,8-cineol, 1,4-cineol, α-terpineol, β-terpineol, and γ-terpineol. The terpene compound may be used solely, or at least two or more of them may be used in combination.

The terpene polymer is obtained, for example, by polymerizing the terpene compound. Examples of the terpene polymer include α-pinene polymer, β-pinene polymer, limonene polymer, dipentene polymer, and β-pinene/limonene polymer.

The terpene-phenol copolymer (sometimes referred to as “terpene-phenolic resin”) is, for example, a copolymer of the terpene compound and a phenol-based compound. Examples of the phenol-based compound include phenol, cresol, xylenol, catechol, resorcin, hydroquinone, and bisphenol A. As the terpene-phenol copolymer, a copolymer of the terpene compound and phenol is preferable.

The acid value of the terpene-phenol copolymer is preferably 10 mgKOH/g or more, more preferably 35 mgKOH/g or more, and even more preferably 60 mgKOH/g or more. In addition, the acid value of the terpene-phenol copolymer is preferably 300 mgKOH/g or less, more preferably 250 mgKOH/g or less, even more preferably 200 mgKOH/g or less, particularly preferably 150 mgKOH/g or less, and most preferably 90 mgKOH/g or less. It is noted that the acid value of the terpene-phenol copolymer is an amount of potassium hydroxide in milligrams required to neutralize the acid included in one gram of the terpene-phenol copolymer, and is a value measured by a potentiometric titration method (JIS K 0070: 1992).

The hydroxy value of the terpene-phenol copolymer is preferably 30 mgKOH/g or more, more preferably 50 mgKOH/g or more. The hydroxy value of the terpene-phenol copolymer is preferably 150 mgKOH/g or less, more preferably 100 mgKOH/g or less. It is noted that in the present specification, the hydroxy value is an amount of potassium hydroxide in milligrams required to neutralize acetic acid bonding to the hydroxy group when acetylating one gram of the resin, and is a value measured by a potentiometric titration method (JIS K 0070: 1992).

The terpene-styrene copolymer is, for example, a copolymer of the terpene compound and a styrene-based compound. Examples of the styrene-based compound include styrene, and α-methylstyrene. As the terpene-styrene copolymer, a copolymer of the terpene compound and α-methylstyrene is preferable.

The terpene-phenol-styrene copolymer is, for example, a copolymer of the terpene compound, the phenol-based compound and the styrene-based compound. As the terpene-phenol-styrene copolymer, a copolymer of the terpene compound, phenol and α-methylstyrene is preferable.

The hydrogenated terpene-phenol copolymer is obtained by hydrogenating the terpene-phenol copolymer. The hydrogenated terpene-styrene copolymer is obtained by hydrogenating the terpene-styrene copolymer. The hydrogenated terpene-phenol-styrene copolymer is obtained by hydrogenating the terpene-phenol-styrene copolymer.

As (g) the terpene-based resin, α-pinene-phenol copolymer, α-pinene-α-methylstyrene copolymer, α-pinene-α-methylstyrene-phenol copolymer, β-pinene-phenol copolymer, β-pinene-α-methylstyrene copolymer, β-pinene-α-methylstyrene-phenol copolymer are particularly preferable. As (g) the terpene-based resin, these copolymers may be used solely, or two or more of them may be used in combination.

The softening point of (g) the terpene-based resin is preferably 60° C. or more, more preferably 80° C. or more, and even more preferably 100° C. or more, and is preferably 150° C. or less, more preferably 130° C. or less, and even more preferably 120° C. or less. If (g) the terpene-based resin having a softening point falling within the above range is used, the resin has better dispersibility in the rubber kneading. It is noted that the softening point of (g) the terpene-based resin is measured with a ring and ball type softening point measuring apparatus according to JIS K 6220-1: 2001, and is a temperature at which the ball drops.

As (g) the terpene-based resin, commercially available products can be used, and examples thereof include Sylvares TP2019 and Sylvatraxx 6720 available from Kraton Corporation; and YS RESIN PX1150N available from Yasuhara Chemical Co., Ltd.

The amount of (g) the terpene-based resin is preferably 0.5 part by mass or more, more preferably 0.8 part by mass or more, and even more preferably 1 part by mass or more, and is preferably 10 parts by mass or less, more preferably 8 parts by mass or less, and even more preferably 5 parts by mass or less, with respect to 100 parts by mass of (a) the base rubber. If the amount of the component (g) falls within the above range, the hardness distribution of the spherical core is easily controlled.

The rubber composition may further contain an additive such as a filler for adjusting weight or the like, an antioxidant, a peptizing agent, and a softener, where necessary.

The filler blended in the rubber composition is mainly used as a weight adjusting agent for adjusting the weight of the golf ball obtained as a final product, and may be blended where necessary. Examples of the filler include an inorganic filler such as zinc oxide, barium sulfate, calcium carbonate, magnesium oxide, tungsten powder, and molybdenum powder. The amount of the filler is preferably 0.5 part by mass or more, more preferably 1 part by mass or more, and is preferably 30 parts by mass or less, more preferably 25 parts by mass or less, and even more preferably 20 parts by mass or less, with respect to 100 parts by mass of the base rubber. If the amount of the filler is 0.5 part by mass or more, it is easier to adjust the weight, and if the amount of the filler is 30 parts by mass or less, the weight proportion of the rubber component increases and thus the resilience tends to be higher.

The amount of the antioxidant is preferably 0.1 part by mass or more and 1 part by mass or less with respect to 100 parts by mass of (a) the base rubber. In addition, the amount of the peptizing agent is preferably 0.1 part by mass or more and 5 parts by mass or less with respect to 100 parts by mass of (a) the base rubber.

The rubber composition can be obtained by kneading (a) the base rubber, (b) the α,β-unsaturated carboxylic acid having 3 to 8 carbon atoms and/or the metal salt thereof, (c) the crosslinking initiator, and the other optional components. The kneading method is not particularly limited. For example, the kneading can be conducted with a conventional kneading machine such as a kneading roll, a banbury mixer and a kneader.

The spherical core of the golf ball according to the present disclosure can be molded, for example, by heat pressing the core rubber composition. The molding conditions for heat pressing the core rubber composition may be determined appropriately depending on the rubber composition. Generally, the heat pressing is preferably carried out at a temperature of 130° C. to 200° C. for 10 to 60 minutes, or carried out in a two-step heating of heating at a temperature of 130° C. to 150° C. for 20 to 40 minutes followed by heating at a temperature of 160° C. to 180° C. for 5 to 15 minutes.

The construction of the spherical core may be a single-layered construction, or a multi-layered construction, and the single-layered construction is preferable.

The diameter of the spherical core is preferably 34.8 mm or more, more preferably 36.8 mm or more, and even more preferably 38.8 mm or more, and is preferably 42.2 mm or less, more preferably 41.8 mm or less, even more preferably 41.2 mm or less, and most preferably 40.8 mm or less. If the diameter of the spherical core is 34.8 mm or more, the thickness of the cover is not excessively thick and thus the resilience is better. On the other hand, if the diameter of the spherical core is 42.2 mm or less, the thickness of the cover is not excessively thin and thus the cover functions better.

When the spherical core has a diameter in the range from 34.8 mm to 42.2 mm, the compression deformation amount of the spherical core (shrinking amount of the spherical core along the compression direction) when applying a load from an initial load of 98 N to a final load of 1275 N to the spherical core is preferably 2.0 mm or more, more preferably 2.5 mm or more, and even more preferably 3.0 mm or more, and is preferably 5.0 mm or less, more preferably 4.5 mm or less, and even more preferably 4.0 mm or less. If the compression deformation amount is 2.0 mm or more, the shot feeling is better, and if the compression deformation amount is 5.0 mm or less, the resilience is better.

The hardness difference S (=Hs−Ho) between the surface hardness (Hs) and the center hardness (Ho) of the spherical core is preferably 0 or more, more preferably 2 or more, and even more preferably 4 or more, and is preferably 35 or less, more preferably 30 or less, and even more preferably 25 or less in Shore C hardness. The spherical core having the hardness difference S (=Hs−Ho) falling within the above range has an outer-hard and inner-soft construction. The high degree or low degree of the hardness difference of the spherical core having the outer-hard and inner-soft construction contributes to the decrease or increase of the spin rate.

The surface hardness (Hs) of the spherical core is not particularly limited, but the surface hardness (Hs) is preferably 60 or more, more preferably 65 or more, and even more preferably 70 or more, and is preferably 95 or less, more preferably 90 or less, and even more preferably 85 or less in Shore C hardness. If the surface hardness (Hs) falls within the above range, better shot feeling is obtained.

The center hardness (Ho) of the spherical core is not particularly limited, but the center hardness (Ho) is preferably 30 or more, more preferably 35 or more, and even more preferably 40 or more, and is preferably 70 or less, more preferably 65 or less, and even more preferably 60 or less in Shore C hardness. If the center hardness (Ho) of the spherical core falls within the above range, better shot feeling is obtained.

The golf ball according to the present disclosure comprises an outermost cover positioned outside the core. The outermost cover is preferably formed from a cover composition containing a resin component. In addition, in the case that the golf ball according to the present disclosure comprises an inner cover, the inner cover is preferably formed from a cover composition containing a resin component.

Examples of the resin component forming the outermost cover and the inner cover include an ionomer resin, a thermoplastic polyurethane elastomer having a trade name of “Elastollan (registered trademark)” available from BASF Japan Ltd., a thermoplastic polyamide elastomer having a trade name of “Pebax (registered trademark)” available from Arkema K. K., a thermoplastic polyester elastomer having a trade name of “Hytrel (registered trademark)” available from Du Pont-Toray Co., Ltd., and a thermoplastic styrene elastomer having a trade name of “Tefabloc” available from Mitsubishi Chemical Corporation.

Examples of the ionomer resin include a product prepared by neutralizing at least a part of carboxyl groups in a binary copolymer composed of an olefin and an α, β-unsaturated carboxylic acid having 3 to 8 carbon atoms with a metal ion; a product prepared by neutralizing at least a part of carboxyl groups in a ternary copolymer composed of an olefin, an α,β-unsaturated carboxylic acid having 3 to 8 carbon atoms and an α,β-unsaturated carboxylic acid ester with a metal ion; and a mixture of those. The olefin is preferably an olefin having 2 to 8 carbon atoms. Examples of the olefin include ethylene, propylene, butene, pentene, hexene, heptene and octene, and ethylene is particularly preferred. Examples of the α,β-unsaturated carboxylic acid having 3 to 8 carbon atoms include acrylic acid, methacrylic acid, fumaric acid, maleic acid and crotonic acid, and acrylic acid or methacrylic acid is particularly preferred. In addition, examples of the α,β-unsaturated carboxylic acid ester include a methyl ester, an ethyl ester, a propyl ester, an n-butyl ester, an isobutyl ester of acrylic acid, methacrylic acid, fumaric acid and maleic acid, and an acrylic acid ester or a methacrylic acid ester is particularly preferred. Among them, as the ionomer resin, a metal ion neutralized product of ethylene-(meth)acrylic acid binary copolymer or a metal ion neutralized product of ethylene-(meth)acrylic acid-(meth)acrylic acid ester ternary copolymer is preferred.

Specific examples of the ionomer resin include trade names of “Himilan (registered trademark) (e.g. the binary copolymer ionomer resin such as Himilan 1555 (Na), Himilan 1557 (Zn), Himilan 1605 (Na), Himilan 1706 (Zn), Himilan 1707 (Na), Himilan AM3711 (Mg), and Himilan AM7329 (Zn); and the ternary copolymer ionomer resin such as Himilan 1856 (Na), and Himilan 1855 (Zn))” available from Mitsui-Du Pont Polychemicals Co., Ltd.

Specific examples of the ionomer resin further include trade names of “Surlyn (registered trademark) (e.g. the binary copolymer ionomer resin such as Surlyn 8945 (Na), Surlyn 9945 (Zn), Surlyn 8140 (Na), Surlyn 8150 (Na), Surlyn 9120 (Zn), Surlyn 9150 (Zn), Surlyn 6910 (Mg), Surlyn 6120 (Mg), Surlyn 7930 (Li), Surlyn 7940 (Li), and Surlyn AD8546 (Li); and the ternary copolymer ionomer resin such as Surlyn 8120 (Na), Surlyn 8320 (Na), Surlyn 9320 (Zn), Surlyn 6320 (Mg), HPF 1000 (Mg), and HPF 2000 (Mg))” available from E.I. du Pont de Nemours and Company.

In addition, specific examples of the ionomer resin include trade names of “lotek (registered trademark) (e.g. the binary copolymer ionomer resin such as lotek 8000 (Na), lotek 8030 (Na), lotek 7010 (Zn), and lotek 7030 (Zn); and the ternary copolymer ionomer resin such as lotek 7510 (Zn), and lotek 7520 (Zn))” available from ExxonMobil Chemical Corporation.

It is noted that Na, Zn, Li, Mg or the like described in the parentheses after the trade names of the ionomer resin indicate a metal ion type for neutralizing the ionomer resin. The ionomer resin may be used solely or as a mixture of at least two of them.

The cover composition preferably contains the thermoplastic polyurethane elastomer or ionomer resin as the resin component. The amount of the thermoplastic polyurethane elastomer or ionomer resin in the resin component of the cover composition is preferably 50 mass % or more, more preferably 60 mass % or more, and even more preferably 70 mass % or more. The resin component of the cover composition may consist of the thermoplastic polyurethane elastomer or ionomer resin.

The cover composition may contain a pigment component such as a white pigment (e.g. titanium oxide), a blue pigment and a red pigment, a weight adjusting agent such as zinc oxide, calcium carbonate and barium sulfate, a dispersant, an antioxidant, an ultraviolet absorber, a light stabilizer, a fluorescent material or fluorescent brightener, or the like, in addition to the above resin component, as long as these components don't impair the function of the cover.

The amount of the white pigment (e.g. titanium oxide) is preferably 0.5 part by mass or more, more preferably 1 part by mass or more, and even more preferably 1.5 parts by mass or more, and is preferably 10 parts by mass or less, more preferably 8 parts by mass or less, and even more preferably 6 parts by mass or less, with respect to 100 parts by mass of the resin component constituting the cover. If the amount of the white pigment is 0.5 part by mass or more, it is possible to impart the opacity to the cover. In addition, if the amount of the white pigment is 10 parts by mass or less, the durability of the obtained cover is not impaired.

Examples of the method for molding the cover include a method which comprises molding the cover composition into a hollow shell, covering the core with a plurality of the shells, and performing compression molding (preferably a method which comprises molding the cover composition into a hollow half-shell, covering the core with two of the half-shells, and performing compression molding); and a method which comprises injection molding the cover composition directly onto the core.

When molding the cover in a compression molding method, molding of the half shell can be performed by either the compression molding method or the injection molding method, and the compression molding method is preferred. Compression molding the resin composition into a half shell can be carried out, for example, under a pressure of 1 MPa or more and 20 MPa or less at a temperature of −20° C. or more and 70° C. or less relative to the flow beginning temperature of the resin composition. By performing the molding under the above conditions, the half shell having a uniform thickness can be formed. Examples of the method for molding the cover by using the half shell include a method which comprises covering the core with two of the half shells and then performing compression molding. Compression molding half shells into the cover can be carried out, for example, under a pressure of 0.5 MPa or more and 25 MPa or less at a temperature of −20° C. or more and 70° C. or less relative to the flow beginning temperature of the resin composition. By performing the molding under the above conditions, the cover having a uniform thickness can be formed.

In the case of injection molding the cover composition into the cover, the cover composition extruded in a pellet form may be used for injection molding, or the cover materials such as the base resin components and the pigment may be dry blended, followed by directly injection molding the blended material. It is preferred to use upper and lower molds having a hemispherical cavity and pimples for forming the cover, wherein a part of the pimples also serves as a retractable hold pin. When molding the cover by injection molding, the hold pin is protruded to hold the core, the cover composition is charged and then cooled to obtain the cover. For example, the resin composition heated at a temperature ranging from 200° C. to 250° C. is charged into a mold held under a pressure of 9 MPa to 15 MPa for 0.5 to 5 seconds, and after cooling for 10 to 60 seconds, the mold is opened to obtain the cover.

The dimples with an inverted shape of the pimples formed on the cavity surface of the molds, are formed on the outermost cover.

The golf ball body having the cover formed thereon is ejected from the mold, and is preferably subjected to surface treatments such as deburring, cleaning and sandblast where necessary. In addition, if desired, a paint film or a mark may be formed. The thickness of the paint film is not particularly limited, and is preferably 5 μm or more, more preferably 6 μm or more, and even more preferably 7 μm or more, and is preferably 50 μm or less, more preferably 40 μm or less, and even more preferably 30 μm or less. If the thickness of the paint film is 5 μm or more, the paint film is hard to wear off even if the golf ball is continuously used, and if the thickness of the paint film is 50 μm or less, the dimple effect is fully obtained, and the golf ball has enhanced flight performance.

The material hardness C of the outermost cover of the golf ball according to the present disclosure (namely, the slab hardness of the cover composition constituting the cover) is preferably 20 or more, more preferably 25 or more, and even more preferably 30 or more, and is preferably 65 or less, more preferably 64 or less, and even more preferably 63 or less in Shore D hardness. If the material hardness of the outermost cover is 20 or more, the outermost cover has enhanced abrasion resistance. In addition, if the material hardness of the outermost cover is 65 or less, the cover has better durability.

The thickness of the outermost cover is preferably 4.0 mm or less, more preferably 3.0 mm or less, and even more preferably 2.0 mm or less, and the thickness of the outermost cover is preferably 0.3 mm or more, more preferably 0.4 mm or more, and even more preferably 0.5 mm or more. If the thickness of the outermost cover falls within the above range, the obtained golf ball has better resilience or shot feeling.

It is also preferable that the golf ball according to the present disclosure comprises an inner cover between the spherical core and the outermost cover. The slab hardness of the inner cover is preferably 30 or more, more preferably 35 or more, and even more preferably 40 or more, and is preferably 70 or less, more preferably 69 or less, and even more preferably 68 or less in Shore D hardness. If the slab hardness of the inner cover falls within the above range, the shot feeling is softer.

The thickness of the inner cover is preferably 0.2 mm or more, more preferably 0.4 mm or more, and even more preferably 0.6 mm or more, and is preferably 3.0 mm or less, more preferably 2.5 mm or less, and even more preferably 2.0 mm or less. If the thickness of the inner cover falls within the above range, the durability is better, and the shot feeling is softer and better.

The inner cover may have one layer or at least two layers.

The golf ball according to the present disclosure preferably has a diameter ranging from 40 mm to 45 mm. In light of satisfying the regulation of US Golf Association (USGA), the diameter is particularly preferably 42.67 mm or more. In light of prevention of air resistance, the diameter is more preferably 44 mm or less, and particularly preferably 42.80 mm or less. In addition, the golf ball according to the present disclosure preferably has a mass of 40 g or more and 50 g or less. In light of obtaining greater inertia, the mass is more preferably 44 g or more, and particularly preferably 45.00 g or more. In light of satisfying the regulation of USGA, the mass is particularly preferably 45.93 g or less.

When the golf ball according to the present disclosure has a diameter in the range of from 40 mm to 45 mm, the compression deformation amount (shrinking amount along the compression direction) of the golf ball when applying a load from an initial load of 98 N to a final load of 1275 N to the golf ball is preferably 3.4 mm or more, more preferably 3.6 mm or more, and even more preferably 3.8 mm or more, and is preferably 5.4 mm or less, more preferably 5.2 mm or less, and even more preferably 5.0 mm or less. If the compression deformation amount is 3.4 mm or more, the golf ball is not excessively hard and thus has better shot feeling. On the other hand, if the compression deformation amount is 5.4 mm or less, the durability is higher.

### EXAMPLES

Next, the present disclosure will be described in detail by way of examples. However, the present disclosure is not limited to the examples described below. Various changes and modifications without departing from the spirit of the present disclosure are included in the scope of the present disclosure.

### [Evaluation Method]

### (1) Compression Deformation Amount (Mm)

The compression deformation amount was measured with a YAMADA type compression tester “SCH”. The golf ball or core was placed on a metal rigid plate of the tester. A metal cylinder slowly fell toward the golf ball or core. The golf ball or core sandwiched between the bottom of the cylinder and the rigid plate deformed. The travelling distance of the cylinder when applying a load from an initial load of 98 N to a final load of 1275 N to the golf ball or core was measured. The compression deformation amount (mm) is the travelling distance. The travelling speed of the cylinder before applying the initial load was 0.83 mm/s. The travelling speed of the cylinder when applying the load from the initial load to the final load was 1.67 mm/s.

### (2) Material (Slab) Hardness (Shore D Hardness)

Sheets with a thickness of about 2 mm were produced by injection molding the intermediate layer composition or cover composition. The sheets were stored at a temperature of 23° C. for two weeks. At least three of these sheets were stacked on one another so as not to be affected by the measuring substrate on which the sheets were placed, and the hardness of the stack was measured with an automatic hardness tester (Digitest II, available from Bareiss company) using a testing device of “Shore D”.

### (3) Core Hardness Distribution (Shore C Hardness)

A type P1 auto loading durometer available from Kobunshi Keiki Co., Ltd. provided with a Shore C type spring hardness tester was used to measure the hardness of the core. The Shore C hardness measured at the surface portion of the core was adopted as the surface hardness of the core. In addition, the core was cut into two hemispheres to obtain a cut plane, and the hardness at the central point of the cut plane was measured.

### (4) Flight Distance (m) on a Driver Shot

A driver (W #1) (trade name “XXIO PRIME (made in 2021)”, Shaft hardness: R2, Loft angle: 11.5°, available from Sumitomo Rubber Industries, Ltd.) was installed on a swing machine available from Golf Laboratories, Inc. The golf ball was hit at a head speed of 30 m/sec, and the flight distance (m) from the launch point to the stop point was measured. The measurement was conducted twelve times for each golf ball, and the average value of the obtained data was adopted as the measurement value for that golf ball. The flight distance is shown as a difference from the flight distance of the golf ball No. 21. The golf ball traveling a great flight distance has excellent flight performance.

### (5) Flight Performance on a Second or Subsequent Shot

### Flight Distance (m) on a Middle Iron Shot

A 7-iron (I #7) (trade name “XXIO PRIME (made in 2021)”, Shaft hardness: R2, available from Sumitomo Rubber Industries, Ltd.) was installed on a swing machine available from Golf Laboratories, Inc. The golf ball was hit at a head speed of 25 m/sec, and the flight distance (m) from the launch point to the stop point was measured. The measurement was conducted twelve times for each golf ball, and the average value of the obtained data was adopted as the measurement value for that golf ball. The flight distance is shown as a difference from the flight distance of the golf ball No. 21. The golf ball travelling a great flight distance has excellent flight performance.

### Rolling Distance (Run) (m) on a Short Iron

A 9-iron (I #9) (trade name “XXIO PRIME (made in 2021)”, Shaft hardness: R2, available from Sumitomo Rubber Industries, Ltd.) was installed on a swing machine available from Golf Laboratories, Inc. The golf ball was hit at a head speed of 23 m/sec, and the rolling distance (run, m) from the fall point to the stop point was measured. The measurement was conducted twelve times for each golf ball, and the average value of the obtained data was adopted as the measurement value for that golf ball. The rolling distance is shown as a difference from the rolling distance of the golf ball No. 21. The golf ball having less rolling distance (run) has excellent stability.

### Spin Rate (Rpm) on an Approach Shot

A sand wedge SW (trade name “XXIO PRIME (made in 2021)”, Shaft hardness: R2, available from Sumitomo Rubber Industries, Ltd.) was installed on a swing machine available from Golf Laboratories, Inc. The golf ball was hit at a head speed of 16 m/sec, and the backspin rate (rpm) was measured. The backspin rate was measured by continuously taking a sequence of photographs right after hitting the golf ball. The measurement was conducted twelve times for each golf ball, and the average value of the obtained data was adopted as the measurement value for that golf ball. The spin rate is shown as a difference from the spin rate of the golf ball No. 21. The golf ball having a high spin rate has excellent stability.

### [Production of Golf Ball]

### (1) Production of Core

The rubber compositions having the formulations shown in Table 1 were kneaded with a kneading roll, and molded in upper and lower molds, each having a hemispherical cavity, under the vulcanizing conditions shown in Table 1 to obtain the spherical cores having a diameter ranging from 39.1 mm to 40.5 mm. It is noted that the amount of barium sulfate was adjusted such that the golf balls had a mass of 45.6 g.

TABLE 1

| Spherical core No. | | 1 | 2 | 3 | 4 | 5 |
|---|---|---|---|---|---|---|
| Formulation | Polybutadiene rubber | 100 | 100 | 100 | 100 | 100 |
| (parts by mass) | Zinc acrylate | 28.5 | 26.4 | 25 | 28.5 | 28.5 |
| | Zinc oxide | 5 | 5 | 5 | 5 | 5 |
| | Barium sulfate | 20.4 | 16.4 | 16.8 | 20.4 | 20.4 |
| | Dicumyl peroxide | 0.9 | 0.7 | 0.9 | 0.9 | 0.9 |
| | Zinc salt of pentachlorothiophenol | 0.90 | 0.70 | 0.90 | 0.90 | 0.90 |
| | Benzoic acid | — | — | 2.00 | — | — |
| | Terpene-based resin | 3 | — | — | 3 | 3 |
| Molding | Molding temperature (° C.) | 150 | 160 | 160 | 150 | 150 |
| conditions | Molding time (min) | 22 | 14 | 16 | 22 | 22 |

| | | | | | |
|---|---|---|---|---|---|
| Core diameter (mm) | 39.8 | 39.8 | 39.8 | 40.5 | 39.1 |
| Compression deformation amount (mm) | 3.8 | 3.8 | 3.8 | 3.8 | 3.8 |
| Core center hardness Ho (Shore C) | 67 | 66 | 58 | 67 | 67 |
| Core surface hardness Hs (Shore C) | 72 | 81 | 83 | 72.5 | 71.5 |

Polybutadiene: “BR-730 (high-cis polybutadiene)” available from JSR Corporation
Zinc acrylate: “ZN-DA90S” available from Nisshoku Techno Fine Chemical Co., Ltd.
Zinc oxide: “Ginrei R” available from Toho Zinc Co., Ltd.
Barium sulfate: “Barium sulfate BD” available from Sakai Chemical Industry Co., Ltd.
Benzoic acid: (purity: at least 98%) available from Tokyo Chemical Industry Co. Ltd.
Zinc salt of pentachlorothiophenol: available from Tokyo Chemical Industry Co., Ltd.
Terpene-based resin (polyterpene phenol): “YS POLYSTER T130” available from Yasuhara Chemical Co., Ltd.
Dicumyl peroxide: “Percumyl (registered trademark) D” available from NOF Corporation

### (2) Preparation of Cover Composition

According to the formulations shown in Table 2, the materials were mixed with a twin-screw kneading type extruder to prepare the cover compositions in a pellet form. The extruding conditions were a screw diameter of 45 mm, a screw rotational speed of 200 rpm, and screw L/D=35, and the mixture was heated to 160 to 240° C. at the die position of the extruder.

TABLE 2

| Cover composition No. | 1 | 2 | 3 | 4 |
|---|---|---|---|---|
| Himilan AM7337 | 20 | 30 | 38 | 46 |
| Himilan AM7329 | 20 | 30 | 38 | 46 |
| TEFABLOC T3221C | 60 | 40 | 24 | 8 |
| Titanium dioxide | 4 | 4 | 4 | 4 |
| JF-90 | 0.2 | 0.2 | 0.2 | 0.2 |
| Shore D hardness | 30 | 40 | 50 | 60 |

Himilan (registered trademark) AM7337: sodium ion neutralized ethylene-methacrylic acid copolymer ionomer resin available from Dow-Mitsui Polychemicals Co., Ltd.
Himilan (registered trademark) AM7329: zinc ion neutralized ethylene-methacrylic acid copolymer ionomer resin available from Dow-Mitsui Polychemicals Co., Ltd.
TEFABLOC (registered trademark) T3221C: thermoplastic styrene based elastomer available from Mitsubishi Chemical Corporation
Titanium dioxide: “A-220” available from Ishihara Sangyo Kaisha, Ltd.

The predetermined pimple shapes were formed on the cavity surface of the mold. The spherical core was charged into the final mold provided with the pimples on the cavity surface thereof, and the hold pin was protruded to hold the spherical core. The cover composition heated at a temperature of 260° C. was charged for 0.3 second into the mold held under a pressure of 80 tons, and cooled for 30 seconds, and the mold was open to eject the golf ball. A plurality of dimples with an inverted shape of the pimples on the cavity surface were formed on the cover. The surface of the obtained golf ball body was subjected to sandblast and marked. A clear paint was applied on the golf ball body and dried in an oven of 40° C. to obtain a golf ball having a diameter of 42.7 mm and a mass of 45.6 g. The specifications of the dimples formed on the outermost cover are shown in Tables 3 to 5. The properties and evaluation results of the obtained golf balls are shown in Tables 6 to 7.

TABLE 3

| | | | Diameter | | | | Upper |
|---|---|---|---|---|---|---|---|
| Dimple | | | Dm | Depth Dp1 | Lower depth | Curvature | volume |
| pattern | Type | Number | (mm) | (mm) | DP2 (mm) | CR (mm) | (mm³) |
| 1 | A | 60 | 4.400 | 0.2526 | 0.1389 | 17.5 | 0.86 |
| | B | 158 | 4.285 | 0.2467 | 0.1389 | 16.6 | 0.78 |
| | C | 72 | 4.150 | 0.2400 | 0.1389 | 15.6 | 0.68 |
| | D | 36 | 3.875 | 0.2270 | 0.1389 | 13.6 | 0.52 |
| | E | 12 | 3.000 | 0.1917 | 0.1389 | 8.2 | 0.19 |
| 2 | A | 60 | 4.400 | 0.2696 | 0.1559 | 15.6 | 0.86 |
| | B | 158 | 4.285 | 0.2637 | 0.1559 | 14.8 | 0.78 |
| | C | 72 | 4.150 | 0.2570 | 0.1559 | 13.9 | 0.68 |
| | D | 36 | 3.875 | 0.2440 | 0.1559 | 12.1 | 0.52 |
| | E | 12 | 3.000 | 0.2087 | 0.1559 | 7.3 | 0.19 |
| 3 | A | 60 | 4.400 | 0.2866 | 0.1729 | 14.1 | 0.86 |
| | B | 158 | 4.285 | 0.2807 | 0.1729 | 13.4 | 0.78 |
| | C | 72 | 4.150 | 0.2740 | 0.1729 | 12.5 | 0.68 |
| | D | 36 | 3.875 | 0.2610 | 0.1729 | 10.9 | 0.52 |
| | E | 12 | 3.000 | 0.2257 | 0.1729 | 6.6 | 0.19 |
| 4 | A | 60 | 4.400 | 0.3036 | 0.1899 | 12.8 | 0.86 |
| | B | 158 | 4.285 | 0.2977 | 0.1899 | 12.2 | 0.78 |
| | C | 72 | 4.150 | 0.2910 | 0.1899 | 11.4 | 0.68 |
| | D | 36 | 3.875 | 0.2780 | 0.1899 | 10.0 | 0.52 |
| | E | 12 | 3.000 | 0.2427 | 0.1899 | 6.0 | 0.19 |

| | | | | Total | Total upper | Total lower | |
|---|---|---|---|---|---|---|---|
| Dimple | | | Lower volume | volume | volume | volume | Total volume |
| pattern | Type | Number | (mm³) | (mm³) | (mm³) | (mm³) | (mm³) |
| 1 | A | 60 | 1.06 | 1.92 | 52 | 63 | 115 |
| | B | 158 | 1.00 | 1.78 | 123 | 158 | 281 |
| | C | 72 | 0.94 | 1.62 | 49 | 68 | 117 |
| | D | 36 | 0.82 | 1.34 | 19 | 30 | 48 |
| | E | 12 | 0.49 | 0.68 | 2 | 6 | 8 |
| 2 | A | 60 | 1.19 | 2.05 | 52 | 71 | 123 |
| | B | 158 | 1.13 | 1.90 | 123 | 178 | 301 |
| | C | 72 | 1.06 | 1.74 | 49 | 76 | 125 |
| | D | 36 | 0.92 | 1.44 | 19 | 33 | 52 |
| | E | 12 | 0.55 | 0.74 | 2 | 7 | 9 |
| 3 | A | 60 | 1.32 | 2.18 | 52 | 79 | 131 |
| | B | 158 | 1.25 | 2.03 | 123 | 197 | 320 |
| | C | 72 | 1.17 | 1.86 | 49 | 84 | 134 |
| | D | 36 | 1.02 | 1.54 | 19 | 37 | 56 |
| | E | 12 | 0.61 | 0.80 | 2 | 7 | 10 |
| 4 | A | 60 | 1.45 | 2.31 | 52 | 87 | 139 |
| | B | 158 | 1.37 | 2.15 | 123 | 217 | 340 |
| | C | 72 | 1.29 | 1.97 | 49 | 93 | 142 |
| | D | 36 | 1.12 | 1.64 | 19 | 40 | 59 |
| | E | 12 | 0.67 | 0.86 | 2 | 8 | 10 |

TABLE 4

| | | | | | | | Upper |
|---|---|---|---|---|---|---|---|
| Dimple | | | Diameter Dm | Depth Dp1 | Lower depth | Curvature | volume |
| pattern | Type | Number | (mm) | (mm) | DP2 (mm) | CR (mm) | (mm³) |
| 5 | A | 60 | 4.400 | 0.3206 | 0.2069 | 11.8 | 0.86 |
| | B | 158 | 4.285 | 0.3147 | 0.2069 | 11.2 | 0.78 |
| | C | 72 | 4.150 | 0.3080 | 0.2069 | 10.5 | 0.68 |
| | D | 36 | 3.875 | 0.2950 | 0.2069 | 9.2 | 0.52 |
| | E | 12 | 3.000 | 0.2597 | 0.2069 | 5.5 | 0.19 |
| 6 | A | 60 | 4.400 | 0.3375 | 0.2238 | 10.9 | 0.86 |
| | B | 158 | 4.285 | 0.3316 | 0.2238 | 10.4 | 0.78 |
| | C | 72 | 4.150 | 0.3249 | 0.2238 | 9.7 | 0.68 |
| | D | 36 | 3.875 | 0.3119 | 0.2238 | 8.5 | 0.52 |
| | E | 12 | 3.000 | 0.2766 | 0.2238 | 5.1 | 0.19 |
| 7 | A | 60 | 4.400 | 0.3586 | 0.2449 | 10.0 | 0.86 |
| | B | 158 | 4.285 | 0.3527 | 0.2449 | 9.5 | 0.78 |
| | C | 72 | 4.150 | 0.3460 | 0.2449 | 8.9 | 0.68 |
| | D | 36 | 3.875 | 0.3330 | 0.2449 | 7.8 | 0.52 |
| | E | 12 | 3.000 | 0.2977 | 0.2449 | 4.7 | 0.19 |

| | | | | | Total upper | Total lower | Total |
|---|---|---|---|---|---|---|---|
| Dimple | | | Lower volume | Total volume | volume | volume | volume |
| pattern | Type | Number | (mm³) | (mm³) | (mm³) | (mm³) | (mm³) |
| 5 | A | 60 | 1.58 | 2.44 | 52 | 95 | 147 |
| | B | 158 | 1.50 | 2.27 | 123 | 236 | 359 |
| | C | 72 | 1.40 | 2.09 | 49 | 101 | 150 |
| | D | 36 | 1.22 | 1.74 | 19 | 44 | 63 |
| | E | 12 | 0.74 | 0.92 | 2 | 9 | 11 |
| 6 | A | 60 | 1.71 | 2.57 | 52 | 102 | 154 |
| | B | 158 | 1.62 | 2.40 | 123 | 256 | 379 |
| | C | 72 | 1.52 | 2.20 | 49 | 109 | 159 |
| | D | 36 | 1.33 | 1.85 | 19 | 48 | 66 |
| | E | 12 | 0.80 | 0.98 | 2 | 10 | 12 |
| 7 | A | 60 | 1.87 | 2.73 | 52 | 112 | 164 |
| | B | 158 | 1.77 | 2.55 | 123 | 280 | 403 |
| | C | 72 | 1.66 | 2.35 | 49 | 120 | 169 |
| | D | 36 | 1.45 | 1.97 | 19 | 52 | 71 |
| | E | 12 | 0.87 | 1.06 | 2 | 10 | 13 |

TABLE 5

| Dimple pattern No. | 1 | 2 | 3 | 4 | 5 | 6 | 7 |
|---|---|---|---|---|---|---|---|
| Front view | FIG. 2 | FIG. 2 | FIG. 2 | FIG. 2 | FIG. 2 | FIG. 2 | FIG. 2 |
| Plane view | FIG. 3 | FIG. 3 | FIG. 3 | FIG. 3 | FIG. 3 | FIG. 3 | FIG. 3 |
| Total number | 338 | 338 | 338 | 338 | 338 | 338 | 338 |
| Total volume V (mm³) | 570 | 610 | 650 | 690 | 730 | 770 | 820 |
| Total upper volume Vo (mm³) | 245 | 245 | 245 | 245 | 245 | 245 | 245 |
| Total lower volume Vi (mm³) | 325 | 365 | 405 | 445 | 485 | 525 | 575 |
| Occupation ratio (%) | 81.6 | 81.6 | 81.6 | 81.6 | 81.6 | 81.6 | 81.6 |

TABLE 6

| Golf ball No. | 1 | 2 | 3 | 4 | 5 | 6 |
|---|---|---|---|---|---|---|
| Spherical core No. | 1 | 4 | 1 | 5 | 1 | 2 |
| Diameter (mm) | 39.8 | 40.5 | 39.8 | 39.1 | 39.8 | 39.8 |
| Compression deformation amount (mm) | 3.8 | 3.8 | 3.8 | 3.8 | 3.8 | 3.8 |
| Surface hardness Hs (Shore C) | 72 | 72.5 | 72 | 71.5 | 72 | 81 |
| Center hardness Ho (Shore C) | 67 | 67 | 67 | 67 | 67 | 66 |
| S = Hs − Ho | 5 | 5.5 | 5 | 4.5 | 5 | 15 |
| Cover composition No. | 1 | 2 | 2 | 2 | 3 | 1 |
| Thickness of outermost cover (mm) | 1.45 | 1.10 | 1.45 | 1.80 | 1.45 | 1.45 |
| Material hardness C of outermost cover (Shore D) | 30 | 40 | 40 | 40 | 50 | 30 |
| Dimple pattern No. | 7 | 6 | 6 | 6 | 6 | 6 |
| Total lower volume Vi (mm³) | 575 | 525 | 525 | 525 | 525 | 525 |
| Total upper volume Vo (mm³) | 245 | 245 | 245 | 245 | 245 | 245 |
| Total volume V (mm³) | 820 | 770 | 770 | 770 | 770 | 770 |
| Compression deformation amount of golf ball | 3.47 | 3.32 | 3.37 | 3.42 | 3.17 | 3.53 |
| (mm) | | | | | | |
| S + C | 35 | 45.5 | 45 | 44.5 | 55 | 45 |
| Vi − 1.85 × Vo | 121.8 | 71.8 | 71.8 | 71.8 | 71.8 | 71.8 |
| V − S × C | 670.0 | 550.0 | 570.0 | 590.0 | 520.0 | 320.0 |
| W#1 flight distance (m) | 0.2 | 1.3 | 1.6 | 1.5 | 1.0 | 0.9 |
| I#7 flight distance (m) | 0.8 | 1.1 | 1.4 | 1.4 | 0.8 | 1.4 |
| I#9 run (m) | −12 | −10 | −11 | −12 | −10 | −11 |
| SW spin rate (rpm) | 1,530 | 1,318 | 1,460 | 1,608 | 1,400 | 1,150 |

| Golf ball No. | 7 | 8 | 9 | 10 | 11 | 12 |
|---|---|---|---|---|---|---|
| Spherical core No. | 2 | 2 | 3 | 3 | 1 | 1 |
| Diameter (mm) | 39.8 | 39.8 | 39.8 | 39.8 | 39.8 | 39.8 |
| Compression deformation amount (mm) | 3.8 | 3.8 | 3.8 | 3.8 | 3.8 | 3.8 |
| Surface hardness Hs (Shore C) | 81 | 81 | 83 | 83 | 72 | 72 |
| Center hardness Ho (Shore C) | 66 | 66 | 58 | 58 | 67 | 67 |
| S = Hs − Ho | 15 | 15 | 25 | 25 | 5 | 5 |
| Cover composition No. | 2 | 3 | 1 | 2 | 1 | 2 |
| Thickness of outermost cover (mm) | 1.45 | 1.45 | 1.45 | 1.45 | 1.45 | 1.45 |
| Material hardness C of outermost cover (Shore D) | 40 | 50 | 30 | 40 | 30 | 40 |
| Dimple pattern No. | 6 | 6 | 6 | 6 | 5 | 5 |
| Total lower volume Vi (mm³) | 525 | 525 | 525 | 525 | 485 | 485 |
| Total upper volume Vo (mm³) | 245 | 245 | 245 | 245 | 245 | 245 |
| Total volume V (mm³) | 770 | 770 | 770 | 770 | 730 | 730 |
| Compression deformation amount of golf ball (mm) | 3.43 | 3.23 | 3.59 | 3.49 | 3.47 | 3.37 |
| S + C | 55 | 65 | 55 | 65 | 35 | 45 |
| Vi − 1.85 × Vo | 71.8 | 71.8 | 71.8 | 71.8 | 31.8 | 31.8 |
| V − S × C | 170.0 | 20.0 | 20.0 | −230.0 | 580.0 | 530.0 |
| W#1 flight distance (m) | 0.8 | 0.4 | 0.1 | 0.2 | 0.7 | 1.1 |
| I#7 flight distance (m) | 0.8 | 0.4 | 0.8 | 0.4 | 1.2 | 1.0 |
| I#9 run (m) | −10 | −8 | −10 | −8 | −11 | −10 |
| SW spin rate (rpm) | 960 | 775 | 775 | 460 | 1,525 | 1,460 |

TABLE 7

| Golf ball No. | 13 | 14 | 15 | 16 | 17 |
|---|---|---|---|---|---|
| Spherical core No. | 1 | 2 | 2 | 3 | 2 |
| Diameter (mm) | 39.8 | 39.8 | 39.8 | 39.8 | 39.8 |
| Compression deformation amount (mm) | 3.8 | 3.8 | 3.8 | 3.8 | 3.8 |
| Surface hardness Hs (Shore C) | 72 | 81 | 81 | 83 | 81 |
| Center hardness Ho (Shore C) | 67 | 66 | 66 | 58 | 66 |
| S = Hs − Ho | 5 | 15 | 15 | 25 | 15 |
| Cover composition No. | 3 | 1 | 2 | 1 | 1 |
| Thickness of outermost cover (mm) | 1.45 | 1.45 | 1.45 | 1.45 | 1.45 |
| Material hardness C of outermost cover (Shore D) | 50 | 30 | 40 | 30 | 30 |
| Dimple pattern No. | 5 | 5 | 5 | 5 | 4 |
| Total lower volume Vi (mm³) | 485 | 485 | 485 | 485 | 445 |
| Total upper volume Vo (mm³) | 245 | 245 | 245 | 245 | 245 |
| Total volume V (mm³) | 730 | 730 | 730 | 730 | 690 |
| Compression deformation amount of golf ball (mm) | 3.17 | 3.53 | 3.43 | 3.59 | 3.53 |
| S + C | 55 | 45 | 55 | 55 | 45 |
| Vi − 1.85 × Vo | 31.8 | 31.8 | 31.8 | 31.8 | −8.3 |
| V − S × C | 480.0 | 280.0 | 130.0 | −20.0 | 240.0 |
| W#1 flight distance (m) | 0.2 | 0.4 | 0.0 | −0.7 | −0.3 |
| I#7 flight distance (m) | 0.2 | 1.0 | 0.2 | 0.2 | 0.5 |
| I#9 run (m) | −8 | −10 | −8 | −8 | −7 |
| SW spin rate (rpm) | 1,400 | 1,150 | 960 | 775 | 1,150 |

| Golf ball No. | 18 | 19 | 20 | 21 |
|---|---|---|---|---|
| Spherical core No. | 3 | 3 | 2 | 2 |
| Diameter (mm) | 39.8 | 39.8 | 39.8 | 39.8 |
| Compression deformation amount (mm) | 3.8 | 3.8 | 3.8 | 3.8 |
| Surface hardness Hs (Shore C) | 83 | 83 | 81 | 81 |
| Center hardness Ho (Shore C) | 58 | 58 | 66 | 66 |
| S = Hs − Ho | 25 | 25 | 15 | 15 |
| Cover composition No. | 2 | 1 | 3 | 4 |
| Thickness of outermost cover (mm) | 1.45 | 1.45 | 1.45 | 1.45 |
| Material hardness C of outermost cover (Shore D) | 40 | 30 | 50 | 60 |
| Dimple pattern No. | 4 | 3 | 2 | 1 |
| Total lower volume Vi (mm³) | 445 | 405 | 365 | 325 |
| Total upper volume Vo (mm³) | 245 | 245 | 245 | 245 |
| Total volume V (mm³) | 690 | 650 | 610 | 570 |
| Compression deformation amount of golf ball (mm) | 3.49 | 3.59 | 3.23 | 3.03 |
| S + C | 65 | 55 | 65 | 75 |
| Vi − 1.85 × Vo | −8.3 | −48.3 | −88.3 | −128.3 |
| V − S × C | −310.0 | −100.0 | −140.0 | −330.0 |
| W#1 flight distance (m) | −1.6 | −2.5 | −0.9 | 0.0 |
| I#7 flight distance (m) | −0.9 | −1.1 | −0.6 | 0.0 |
| I#9 run (m) | −6 | −6 | −4 | 0 |
| SW spin rate (rpm) | 460 | 775 | 775 | 0 |

It is apparent from the results shown in Tables 6 and 7 that the golf ball comprising a spherical core, and an outermost cover positioned outside the spherical core and having a plurality of dimples formed thereon, wherein a hardness difference S (=Hs−Ho) between a surface hardness Hs of the spherical core and a center hardness Ho (Shore C hardness) of the spherical core, a material hardness C (Shore D hardness) of the outermost cover, and a total volume V (mm³) of the plurality of dimples below a surface of a virtual sphere satisfy V−S×C≥0, has an excellent flight distance and stability on a second or subsequent shot while maintaining or improving a flight distance on a driver shot for a golfer with a slow head speed.

The golf ball according to the present disclosure is a golf ball having an excellent flight distance and stability on a second or subsequent shot while maintaining or improving a flight distance on a driver shot for a golfer with a slow head speed.

The preferable embodiment (1) according to the present disclosure is a golf ball comprising a spherical core, and an outermost cover positioned outside the spherical core and having a plurality of dimples formed thereon, wherein
a hardness difference S (=Hs−Ho) between a surface hardness Hs of the spherical core and a center hardness Ho (Shore C hardness) of the spherical core,
a material hardness C (Shore D hardness) of the outermost cover, and
a total volume V (mm³) of the plurality of dimples below a surface of a virtual sphere satisfy V−S×C≥0.

The preferable embodiment (2) according to the present disclosure is the golf ball according to the embodiment (1), wherein Vi−1.85×Vo≥0 is satisfied, where Vo is a total upper volume of the dimples, Vi is a total lower volume of the dimples, and V=Vo+Vi.

The preferable embodiment (3) according to the present disclosure is the golf ball according to the embodiment (1) or (2), wherein S+C≤60 is satisfied.

The preferable embodiment (4) according to the present disclosure is the golf ball according to any one of the embodiments (1) to (3), wherein the cover contains an ionomer resin.

This application is based on Japanese patent application No. 2023-101990 filed on Jun. 21, 2023, the content of which is hereby incorporated by reference.

1. A golf ball comprising a spherical core, and an outermost cover positioned outside the spherical core and having a plurality of dimples formed thereon, wherein
a hardness difference S (=Hs−Ho) between a surface hardness Hs of the spherical core and a center hardness Ho (Shore C hardness) of the spherical core,
a material hardness C (Shore D hardness) of the outermost cover, and
a total volume V (mm³) of the plurality of dimples below a surface of a virtual sphere satisfy V−S×C≥0.

2. The golf ball according to claim 1, wherein Vi−1.85×Vo≥0 is satisfied, where Vo is a total upper volume of the dimples, Vi is a total lower volume of the dimples, and V=Vo+Vi.

3. The golf ball according to claim 1, wherein S+C≥60 is satisfied.

4. The golf ball according to claim 1, wherein the cover contains an ionomer resin.

5. The golf ball according to claim 1, wherein the total volume V of the plurality of dimples ranges from 500 mm³ to 900 mm³.

6. The golf ball according to claim 1, wherein the hardness difference S ranges from 0 to 35 in Shore C hardness.

7. The golf ball according to claim 1, wherein the surface hardness Hs of the spherical core ranges from 60 to 95 in Shore C hardness.

8. The golf ball according to claim 1, wherein the center hardness Ho of the spherical core ranges from 30 to 70 in Shore C hardness.

9. The golf ball according to claim 1, wherein the material hardness C of the outermost cover ranges from 20 to 65 in Shore D hardness.

10. The golf ball according to claim 1, wherein S, C, and V satisfy 750≥V−S×C≥150.

11. The golf ball according to claim 2, wherein 160≥Vi−1.85×Vo≥30 is satisfied.

12. The golf ball according to claim 3, wherein 30≤S+C≤60 is satisfied.

13. The golf ball according to claim 1, wherein the spherical core is formed from a rubber composition containing (a) a base rubber, (b) an α,β-unsaturated carboxylic acid having 3 to 8 carbon atoms and/or a metal salt thereof as a co-crosslinking agent, and (c) a crosslinking initiator.

14. The golf ball according to claim 13, wherein the rubber composition further contains (g) a terpene-based resin.

15. The golf ball according to claim 14, wherein an amount of (g) the terpene-based resin ranges from 0.5 part by mass to 10 parts by mass with respect to 100 parts by mass of (a) the base rubber.
